(19) United States
(12) Patent Application Publication
(10) Pub. No.: US 2025/0251495 A1
(43) Pub. Date: Aug. 7, 2025

(54) DEVICE FOR MEASURING A PROPAGATION TIME OF A MEASUREMENT LIGHT BEAM, USER TERMINAL, DETECTION AND LIGHTING APPARATUS, METHOD FOR MEASURING A PROPAGATION TIME OF A MEASUREMENT LIGHT BEAM, COMPUTER PROGRAM AND/OR COMPUTER-READABLE MEDIUM AND DATA PROCESSING DEVICE

(71) Applicant: Carl Zeiss Jena GmbH, Jena (DE)

(72) Inventors: Viktor Schuetz, Kahla (DE); Petr Vojtisek, Jena (DE); Justyna Kramer, Erfurt (DE); Marc Junghans, Jena (DE); Yi Zhong-Schipp, Jena (DE)

(73) Assignee: Carl Zeiss Jena GmbH, Jena (DE)

(21) Appl. No.: 19/186,664

(22) Filed: Apr. 23, 2025

Related U.S. Application Data
(63) Continuation of application No. PCT/EP2023/079520, filed on Oct. 23, 2023.

(30) Foreign Application Priority Data
Oct. 24, 2022 (DE) 10 2022 211 264.4

(51) Int. Cl. G01S 7/481; G01S 7/497; G01S 17/08

(52) U.S. Cl. CPC G01S 7/4818; G01S 7/497; G01S 17/08

(57) ABSTRACT

A device for measuring a time of flight of a measuring light beam, comprising a measuring light source for emitting the beam, a light sensor for detecting the beam, a waveguide, and a data processing device. The waveguide is designed to guide the beam emitted by the measuring light source to an object situated in an object region of the device and the beam reflected off the object to the light sensor at least partially through the waveguide, wherein the waveguide includes a measuring diffraction structure for wavelength-dependent deflection of the beam and wherein the beam traverses a wavelength-dependent path length in the waveguide. The data processing device is configured to determine, when measuring the time of flight, an optical path length contribution and/or a time-of-flight contribution for the beam detected by the light sensor, taking into account the wavelength-dependent path length of the beam within the waveguide.

### CROSS REFERENCE TO RELATED APPLICATIONS

This application is a continuation application of international patent application PCT/EP2023/079520, filed on Oct. 23, 2023, and designating the U.S., which claims priority to German patent application 10 2022 211 264.4, filed on Oct. 24, 2022, each of which are hereby incorporated by reference in their entireties.

### TECHNICAL FIELD

The present disclosure relates to a device for measuring a time of flight of a measuring light beam. The present disclosure also relates to a user terminal, a detection and illumination apparatus, a method for measuring a time of flight of a measuring light beam, a computer program and/or a computer-readable medium and a data processing device.

### BACKGROUND

WO 2020/157306 A1 relates to a functionalized waveguide for a detector system, wherein the waveguide comprises a transparent main body having a front face and a rear face. The main body has a partially transparent incoupling region and a decoupling region that is spaced apart therefrom in a first direction. The incoupling region comprises a diffractive structure which deflects only part of radiation coming from an object to be detected and impinging on the front face in such a way that the deflected part propagates as coupled-in radiation in the main body by reflections up to the decoupling region and impinges on the decoupling region. The decoupling region deflects at least part of the coupled-in radiation impinging thereon in such a way that the deflected part exits the main body via the front face or rear face in order to impinge on the detector system. The extent of the incoupling region in a second direction transverse to the first direction is greater than the extent of the decoupling region in the second direction.

The time of flight of the measuring light beam and hence the result of the measurement of the time of flight and/or a measurement of the distance between the object and the device may be influenced by a wavelength-dependent deflection of the measuring light beam and a wavelength-dependent optical path length of the measuring light beam connected therewith since the measuring light beam is coupled into the waveguide and coupled out from the waveguide differently on account of the different wavelengths, and may thus traverse different optical path lengths.

### SUMMARY

A device for measuring a time of flight of a measuring light beam is provided. The device comprises a measuring light source for emitting the measuring light beam, a light sensor for detecting the measuring light beam, a waveguide, and a data processing device. The waveguide is designed to guide the measuring light beam emitted by the measuring light source to an object situated in an object region of the device and the measuring light beam reflected off the object to the light sensor at least partially through the waveguide. The waveguide includes a measuring diffraction structure for wavelength-dependent deflection of the measuring light beam. The measuring light beam traverses a wavelength-dependent path length in the waveguide. The data processing device is configured to determine, when measuring the time of flight, an optical path length contribution and/or a time-of-flight contribution for the measuring light beam detected by the light sensor, taking into account the wavelength-dependent path length of the measuring light beam within the waveguide.

A method for measuring a time of flight of a measuring light beam is provided. The method comprises guiding the measuring light beam to an object situated in an object region and the measuring light beam reflected off the object to a light sensor at least partially through a waveguide having a measuring diffraction structure for a wavelength-dependent deflection of the measuring light beam, the measuring light beam traversing a wavelength-dependent path length in the waveguide. The method further comprises determining an optical path length contribution and/or a time-of-flight contribution for the measuring light beam detected by the light sensor, taking into account the wavelength-dependent path length of the measuring light beam within the waveguide.

### DESCRIPTION OF THE DRAWINGS

In the drawings:

FIG. 1 shows a schematic illustration of a device for measuring a time of flight according to an aspect of the disclosure;

FIG. 2 shows a schematic illustration of a device for measuring a time of flight according to an aspect of the disclosure;

FIG. 3 shows a schematic illustration of a waveguide of a device for measuring a time of flight according to an aspect of the disclosure, in order to illustrate a wavelength-dependent optical path length contribution;

FIG. 4 shows a schematic illustration of a waveguide of a device for measuring a time of flight according to an aspect of the disclosure, in order to illustrate a wavelength-dependent optical path length contribution;

FIG. 5 shows a schematic illustration of a waveguide of a device for measuring a time of flight according to an aspect of the disclosure, in order to illustrate a wavelength-dependent optical path length contribution;

FIG. 6 shows a schematic illustration of a deflection curve of a measuring diffraction structure of a waveguide of a device for measuring a time of flight according to an aspect of the disclosure;

FIG. 7 shows a schematic illustration of a waveguide of a device for measuring a time of flight according to an aspect of the disclosure, in order to illustrate a wavelength-dependent optical path length contribution;

FIG. 8 shows a schematic illustration of a dependence of a wavelength on a first angle of incidence and on a second angle of incidence of a measuring diffraction structure of a waveguide of a device for measuring a time of flight according to an aspect of the disclosure;

FIG. 9 shows a schematic illustration of a dependence of an optical path length contribution on a first angle of incidence and on a second angle of incidence of a waveguide of a device for measuring a time of flight according to an aspect of the disclosure;

FIG. 10 shows a schematic illustration of a deflection efficiency of a light beam deflected by a measuring diffraction structure;

FIG. 11 shows a schematic illustration of a device for measuring a time of flight according to an aspect of the disclosure;

FIG. 12 shows a schematic illustration of a device for measuring a time of flight according to an aspect of the disclosure; and

FIG. 13 shows a flowchart of a method for measuring a time of flight according to an aspect of the disclosure.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

According to an aspect of the disclosure, a device for measuring a time of flight of a measuring light beam is provided. The device comprises a measuring light source for emitting the measuring light beam, a light sensor for detecting the measuring light beam, a waveguide and a data processing device, wherein the waveguide is designed such that the measuring light beam emitted by the measuring light source to an object situated in an object region of the device and the measuring light beam reflected off the object to the light sensor are at least partially guided through the waveguide, the waveguide comprising a measuring diffraction structure for the wavelength-dependent deflection of the measuring light beam and the measuring light beam traversing a wavelength-dependent path length in the waveguide, wherein the data processing device is configured within the measurement of the time of flight to determine an optical path length contribution and/or a time-of-flight contribution to the measuring light beam detected by the light sensor, taking into account the wavelength-dependent path length of the measuring light beam within the waveguide.

According to an aspect of the disclosure, a user terminal is provided. The user terminal comprises the above-described device for measuring the time of flight of the measuring light beam.

According to an aspect of the disclosure, a detection and illumination apparatus is provided. The detection and illumination apparatus comprises the above-described device for measuring the time of flight of the measuring light beam.

According to an aspect of the disclosure, a method for measuring a time of flight of a measuring light beam is provided. In this case, the method includes: guiding the measuring light beam to an object situated in an object region and the measuring light beam reflected off the object to a light sensor at least partially through a waveguide having a measuring diffraction structure for the wavelength-dependent deflection of the measuring light beam, the measuring light beam traversing a wavelength-dependent path length in the waveguide; and determining an optical path length contribution and/or a time-of-flight contribution to the measuring light beam detected by the light sensor, taking into account the wavelength-dependent path length of the measuring light beam in the waveguide.

According to an aspect of the disclosure, a computer program and/or computer-readable medium is provided, comprising commands which, should the program or the commands be executed by a computer, cause the latter to perform the above-described method and/or the steps of the method.

According to an aspect of the disclosure, a data processing device is provided. In this context, the data processing device is configured to perform the above-described method for measuring a time of flight of a measuring light beam.

The device for measuring the time of flight of the measuring light beam according to an aspect of the disclosure may be configured to determine the time of flight of the measuring light beam. In this case, the time of flight may be a difference between a first time, at which the measuring light beam is emitted by the light source, and a second time, at which the measuring light beam reflected off the object is detected by the light sensor. The path traversed by the measuring light beam may emerge from the time of flight, and this path allows inference of a distance between the device and the object. In some respects, the device for measuring the time of flight of the measuring light beam may, in view of possible fields of application, be similar to the fields of application of a lidar sensor, with the device differing from a lidar sensor at least in the fact that a device according to the disclosure does not necessarily require a laser beam to be moved or scanned over the angle range to be observed. Rather, a device according to the disclosure may allow the emitted measuring light beam to capture the entire measurement region to be captured without needing to move or scan said measuring light beam. Moreover, a device according to the disclosure may inter alia deviate from a lidar sensor in the fact that a possible range of the measurement region deviates from the range of a lidar sensor. Thus, a measurement region of a device according to the disclosure may optionally have a range of approximately 3 m.

The device is optionally configured in such a way that the measuring light beam is at least partially guided through the waveguide along an optical path between the object situated in the object region and the light sensor. In the process, the measuring light beam may enter the waveguide, i.e. be coupled into the waveguide, may traverse an optical path within the waveguide and may emerge from the waveguide, i.e. be decoupled from the waveguide. In this case, the object region may be defined as a capture region or field of view of the device, within which the object may be arranged for the purpose of measuring the time of flight. The measuring light beam may traverse a wavelength-dependent path length within the waveguide since the waveguide comprises the measuring diffraction structure that is configured to deflect the measuring light beam in wavelength-dependent fashion. Wavelength-dependent deflection of the measuring light beam may mean that the measuring light beam traverses different paths within the waveguide depending on the wavelength since the measuring light beam may be coupled differently into the waveguide, i.e. optionally deflected by a different angle, depending on the wavelength.

In order to be able to determine the path length of the measuring light beam as precisely as possible, the data processing device may determine an optical path length contribution of the measuring light beam. In this case, the optical path length contribution optionally specifies a wavelength-dependent optical path length within the waveguide of the measuring light beam for a specific wavelength of the measuring light beam, which is due to the propagation of the measuring light beam through the waveguide at the wavelength. It was recognized that measuring light beams at mutually different wavelengths may traverse different optical path lengths within the waveguide. The measuring light beam may traverse an optical path within the waveguide that is different from a wavelength-independent optical path without the waveguide. Hence, a first portion of the measuring light beam and/or a first measuring light beam at a first wavelength may traverse a first optical path within the waveguide on account of the wavelength-dependent deflection, and a second portion of the measuring light beam and/or a second measuring light beam at a second wavelength that differs from the first wavelength may traverse a second optical path. Hence, the optical path length contribution may depend on the wavelength. The time-of-flight contribution may be defined analogously in the event of a known propagation speed of the measuring light beam within the waveguide. In this case, the time-of-flight contribution may specify a wavelength-dependent time of flight of the measuring light beam within the waveguide for a specific wavelength of the measuring light beam. In other words, a first portion of the measuring light beam and/or a first measuring light beam at a first wavelength may traverse a first optical path within the waveguide during a first time of flight on account of the wavelength-dependent deflection, and a second portion of the measuring light beam and/or a second measuring light beam at a second wavelength that differs from the first wavelength may traverse a second optical path during a second time of flight. Hence, the time-of-flight contribution may depend on the wavelength.

The disclosure offers the advantage that the determination of the path length contribution and/or of the time-of-flight contribution allows the distance between the object and the device to be determined precisely using a polychromatic measuring light beam and/or using measuring light beams at a plurality of wavelengths, and in so doing allows avoidance of the wavelength-dependent deflection of the measuring light beam within the waveguide leading to different measurement results for time of flight that depend on the wavelength of the measuring light beam. Furthermore, it is possible to be able to make targeted use of a polychromatic measuring light beam in order to be able to input couple the measuring light beam into and/or output couple said measuring light beam from the waveguide for example at different angles, in order to increase a capture region of the device for measuring the time of flight. As a result of the wavelength-dependent deflection within the waveguide, it may moreover be possible to provide a waveguide that may be at least partially transparent to the human eye, while the measuring light beam may be deflected. As a result, it is possible to deflect the measuring light beam in such a way that components for measuring the optical path length, i.e. optionally the measuring light source and the light sensor, may be arranged at a location not visible to a user.

The measuring diffraction structure may be configured for wavelength-dependent deflection of the measuring light beam in a near infrared spectral range, NIR range. In this case, the wavelength-dependent deflection is implemented on account of diffraction at the measuring diffraction structure should the measuring light beam satisfy a Bragg condition on account of its wavelength and/or its angle of incidence relative to the measuring diffraction structure. The measuring light beam does not satisfy the Bragg condition outside of the spectral range. Hence, there is no such deflection by the measuring diffraction structure outside of the spectral range. Hence, the measuring diffraction structure may be transparent outside of the spectral range and transmit light outside of the spectral range largely without diffraction and/or deflection. The measuring light beam is not visible to the human eye in that spectral range, increasing the user-friendliness of the device since it is possible to manage without a visible “illumination” of the object by the measuring light beam. Further, the device in one embodiment of the disclosure is able to reconstruct a display and/or an imaging object using visible light, with a crosstalk, i.e. mutual influencing, between the visible light and the measuring light beam being avoided. The measuring diffraction structure may be configured to deflect the measuring light beam in wavelength-dependent fashion in a spectral range from 700 nm to 940 nm and/or to 1100 nm. Hence it is possible to resort to a cost-effective light sensor. Alternatively, a different spectral range in which the measuring diffraction structure is configured for wavelength-dependent deflection is also possible, wherein a different light source, a different light sensor and/or a waveguide made of a different material should be provided to this end.

The light sensor may comprise a plurality of pixels or picture elements, and the data processing device may be configured to retrieve and/or calculate the optical path length contribution and/or time-of-flight contribution for a plurality of the picture elements of a respective detected portion of the measuring light beam. The light sensor comprises the plurality of picture elements or pixels, wherein the picture elements are each configured to detect the measuring light beam and/or a portion of the measuring light beam. In this case, the light sensor comprises a plurality of picture elements in order to provide an improved capture region of the device for measuring the time of flight of the measuring light beam. In this case, it was recognized that the wavelength-dependent deflection of the measuring light beam has as a consequence that spectrally different components of the measuring light beam, i.e. portions of the measuring light beam and/or measuring light beams at different wavelengths, are decoupled differently in the direction of the light sensor from the waveguide. In this case, there is an association between the wavelength of the measuring light beam and one of the picture elements since a portion of the measuring light beam at a specific wavelength is detected by a specific picture element. Hence, the wavelength of the measuring light beam is known for a given picture element, from which it is possible to infer the optical path length of the measuring light beam. Hence, for different picture elements, there is a respective path length contribution which results from the different wavelengths of the portions of the measuring light beam incident on the picture elements.

The optical path length contribution and/or the time-of-flight contribution may correspond to a vertical pixel position and a horizontal pixel position. In this context, the light sensor comprises the plurality of picture elements, and the picture elements are each assignable a vertical pixel position and/or a horizontal pixel position. For example, the picture elements are arranged in the form of a matrix. The wavelength of the measuring light beam may be inferred on the basis of the position of a pixel. Hence, the optical path length contribution may be determined in accordance with the pixel position. The capture region or the field of view may be resolved on the basis of the pixels in the matrix, and an optical path length may be assigned to a respective pixel in the matrix.

The measuring diffraction structure may be configured to input couple the measuring light beam, which was reflected off the object and is incident on a surface of the waveguide at a first angle of incidence of +/−20°, into the waveguide and/or to input couple the measuring light beam, which was reflected off the object and is incident on the surface of the waveguide at a second angle of incidence, defined perpendicular to the first angle of incidence, of +/−20°, into the waveguide. In this case, the first angle of incidence may define a capture region of the device in a vertical direction. The second angle of incidence may define the capture region of the device in a horizontal direction. In this context, it was recognized that the specified ranges of the angles of incidence may be provided effectively in the near infrared spectral range using the waveguide, and optionally using the measuring diffraction structure for deflecting the measuring light beam. By exploiting the spectral range, i.e. emitting the measuring light beam at a plurality of wavelengths within the spectral range, it is thus possible to input couple light from a larger range of angles of incidence into the waveguide in comparison with a known optics unit, and this may increase the capture region vis-à-vis an optics unit with a lens element, for example. The waveguide may also be configured to output couple the measuring light beam from the waveguide with a first exit angle, arranged in a manner analogous to the first angle of incidence, of +/−20° and/or a second exit angle, arranged in a manner analogous to the second angle of incidence, of +/−20°.

The data processing device may be configured to capture distance data related to the object by way of an input device and to calibrate the determination of the optical path length and/or the time of flight on the basis of the distance data. In the process, it was recognized that a calibration of the device is possible in order to also be able to perform a measurement of the time of flight should for example the type of waveguide and/or of measuring diffraction structure be unknown. In this context, the optical path length through the waveguide may be calibrated with the aid of measuring a time of flight of the measuring light signal at a known wavelength and a known object distance.

The device may comprise an image light source for emitting a visible image light beam, and the waveguide may comprise an image diffraction structure for wavelength-dependent deflection of the image light beam. The image light source is optionally configured to input couple the image light beam into the waveguide so that the image light beam is deflected by the image diffraction structure. Optionally, the image light beam may be coupled into the waveguide by an optical structure. The deflected image light beam is decoupled out of or from the waveguide in order to reconstruct a virtual or real image in the visible range, i.e. a visually perceivable representation, outside of the waveguide.

The device may be configured to control the image light source on the basis of the optical path length and/or the time of flight of the measuring light beam. Hence it is possible that the image light source emits image information matched to the object. For example, the object may be a body part of a user, the position of which is captured relative to the waveguide, and the image may be reconstructed or displayed in the surroundings of the waveguide in a manner matched to the position.

The device may be configured to image a user interface that is spaced apart from the waveguide in a second direction and to capture a user input by way of the user interface based on the time of flight of the measuring light beam. In this case, it was recognized that the user interface may be imaged by way of the image light source and the image diffraction structure. In this context, the user interface is reconstructed in such a way that the user interface appears to float in surroundings of the waveguide at a distance from the waveguide. A user may interact with the user interface, for example by virtue of the user positioning a body part in accordance with the user interface. The position of the body part of the user may be captured based on the time of flight of the measuring light beam and may be interpreted as input by the user.

The device may be configured to image an imaging object, which is spaced apart from the waveguide in a second direction, relative to the object. In this context, it was recognized that the device in that example may provide an advantageous application in the field of augmented reality (AR). For example, the object may be a scenery or surroundings of the waveguide, into which the imaging object is imaged. For example, in an application in which a user gazes through the waveguide, the imaging object may be imaged as a virtual object. For example, in an application in which the user gazes at the image light source through the waveguide, the imaging object may be imaged as a real object. So that the imaging object is advantageously imageable, the device captures the geometry of the object by measuring the time of flight of the measuring light beam. Hence, the imaging object may be imaged with a depth corresponding to the object.

The device may be configured to control the image light source dynamically and/or based on a captured movement of the object. In this way, it may be possible to provide dynamic, i.e. time-dependent, applications in the field of augmented reality.

The device may comprise a mirror and/or a prism for deflecting the measuring light beam emerging from the waveguide and/or for deflecting the measuring light beam reflected off the object. A deflection of the measuring light beam emanating from the waveguide and/or of the measuring light beam reflected off the object may be advantageous for the provision for a user terminal since the possible deflection allows the device or its components to be arrangeable in many different ways. As a result, the components of the device, with the exception of the waveguide, may be advantageously arranged in a housing of the user terminal in a manner not visible to a user of the user terminal.

According to an aspect of the disclosure, a user terminal is provided. The user terminal comprises the above-described device for measuring the time of flight of the measuring light beam. In this case, the device of the user terminal may have one or more of the above-described optional technical features in order to obtain a technical effect connected therewith.

According to an aspect of the disclosure, a detection and illumination apparatus is provided. The detection and illumination apparatus comprises the above-described device for measuring the time of flight of the measuring light beam. In this case, the device of the detection and illumination apparatus may have one or more of the above-described optional technical features in order to obtain a technical effect connected therewith.

According to an aspect of the disclosure, a method for measuring a time of flight of a measuring light beam is provided. In this case, the method includes: guiding the measuring light beam to an object and the measuring light beam reflected off the object to a light sensor at least partially through a waveguide having a measuring diffraction structure for the wavelength-dependent deflection of the measuring light beam, the measuring light beam traversing a wavelength-dependent path length in the waveguide; and determining an optical path length contribution and/or a time-of-flight contribution to the measuring light beam detected by the light sensor, taking into account the wavelength-dependent path length of the measuring light beam in the waveguide.

The method may be performed using the above-described device for measuring the time of flight of the measuring light beam. Hence, the descriptions in relation to the device apply analogously to the method, and vice versa.

The optical path length contribution and/or time-of-flight contribution may be determined based on a wavelength-dependent number of total-internal reflections within the waveguide and/or a wavelength-dependent deflection angle within the waveguide. In this context, it was recognized that the number of total-internal reflections and the deflection angle have an influence on the optical path of a measuring light beam within the waveguide. Taking account of the number of total-internal reflections within the waveguide and/or the deflection angle allows the optical path length contribution and/or the time-of-flight contribution to be calculated given a known geometry of the waveguide.

Optionally, the measuring light source and/or the image light source may comprise one or more of the following types of light sources: light-emitting diodes (LEDs), laser diodes, semiconductor lasers and solid-state lasers.

An emission spectrum of the measuring light source may optionally be located in the infrared spectral range in this case. This may offer the advantage that the light emitted by the measuring light source is not visible to the human eye, and accordingly the light emitted by the measuring light source is not perceived as bothersome by humans. Optionally, the emission spectrum may be located in a spectral range in which the waveguide is optically transparent. Optionally, the emission spectrum of the measuring light source may be located in a range from approximately 780 nm to approximately 2 μm. Optionally, the emission spectrum of the measuring light source may be located in a range from approximately 780 nm to approximately 1100 nm. This may offer the advantage that silicon-based detectors, for instance CM OS sensors and/or CCD arrays, may be usable for the detection of the measuring light. For wavelengths located at wavelengths longer than 1100 nm, the choice of a detector suitable to this end may be advantageous, for instance an AlGaAs-based detector and/or an InGaAs-based detector. The choice of detector may be matched to the measuring light source and the emission spectrum of the measuring light source. In this context, the specified spectral ranges do not mean that the emission spectrum must in each case necessarily cover the entire specified spectral range. Instead, the emission spectrum may cover a small spectral range within the given spectral range. Optionally, the measuring light source may have an emission spectrum with a full width at half maximum (FWHM) of 100 nm or less, optionally 50 nm or less and optionally 10 nm or less.

In an alternative to that or in addition, the measuring light source may be designed to provide an emission spectrum at 1.55 μm and/or in a spectral range around 1.55 μm. This spectral range widely used in telecommunications may offer the advantage that the absorption by water, also by moisture in the air, may be low and, accordingly, losses connected therewith may be kept low, whereby a range may be increased and/or the emission power to be provided may be reduced.

Optionally, the one or more utilized diffraction structures or holographic structures may be matched to the emission spectrum of the measuring light source and/or an emission spectrum of the image light source. Optionally, the one or more utilized diffraction structures or holographic structures may be designed to have a high efficiency in the spectral range of the measuring light. Optionally, the one or more utilized diffraction structures or holographic structures may be designed in an intended angle range for the input coupling and/or output coupling of light from the respective diffraction structures or holographic structures.

An emission spectrum of the image light source may optionally be located in the visible range, i.e. for instance in a spectral range between 400 nm and 780 nm. This may offer the advantage that image information represented by means of light emitted by the image light source may be visible to the human eye.

The use of light-emitting diodes as measuring light source or as part thereof may offer the advantage that the measuring light is emitted in a predetermined emission angle range that is greater than zero, rather than a collimated laser beam with an emission angle of virtually zero. A large emission angle range may be realized as a result, and this may lead to a large field of view (FOV), i.e. a large measurement region. Optionally, the measurement region or the FOV may correspond to an angle range of 15° or more and optionally of 50°.

According to an aspect of the disclosure, a computer program and/or computer-readable medium is provided, comprising commands which, should the program or the commands be executed by a computer, cause the latter to perform the above-described method and/or the steps of the method.

According to an aspect of the disclosure, a data processing device is provided. In this context, the data processing device is configured to perform the above-described method for measuring a time of flight of a measuring light beam.

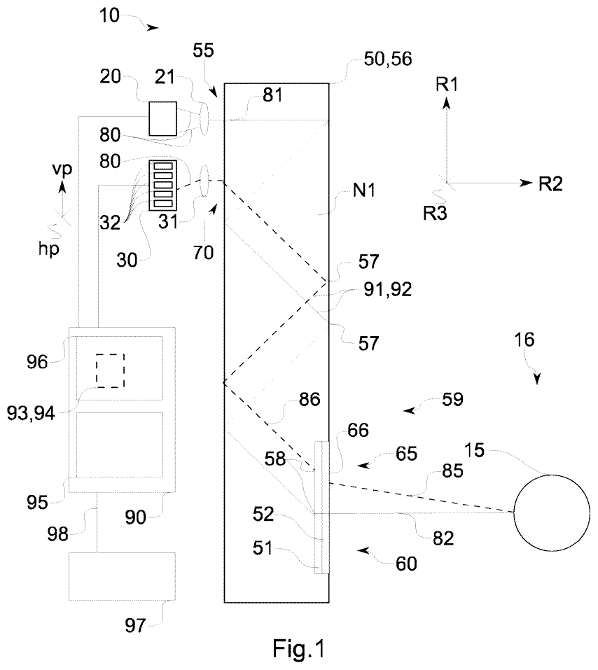

FIG. 1 shows a schematic illustration of a device 10 for measuring a time of flight 92 according to an optional aspect of the disclosure.

The device 10 is configured to measure the time of flight 92 of a measuring light beam 80. To this end, the device 10 comprises a measuring light source 20 for emitting the measuring light beam 80, a light sensor 30 for detecting the measuring light beam 80, a waveguide 50 and a data processing device 90.

The measuring light source 20 is configured to emit the measuring light beam 80. The measuring light beam 80 emitted by the measuring light source 20 in the process comprises light in a near infrared spectral range, NIR range, S and has a wavelength L in the range of 700 nm to 940 nm. For example, the measuring light source 20 comprises a light-emitting diode (LED) and emits the measuring light beam 80 as polychromatic light at a plurality of wavelengths within the NIR range S.

The measuring light source 20 is connected to the data processing device 90 in a manner allowing communication in order to be able to be controlled by the data processing device 90. Hence, the data processing device 90 is able to coordinate, optionally temporally coordinate, the transmission or emission of the measuring light beam 80 and/or able to capture a first time of emission of the measuring light beam 80 by the measuring light source 20.

The device 10 comprises an imaging device 21, which is configured to steer the measuring light beam 80 in the direction of the waveguide 50. For example, the imaging device 21 comprises a prism, a mirror and/or a lens element.

The measuring light beam 80 is coupled into the waveguide 50 in a transmission input coupling region 55 of the waveguide 50 and propagates through the waveguide 50 as measuring light beam 81 coupled into the waveguide 50. In the process, the input-coupled measuring light beam 81 is reflected within the waveguide 50. Optionally, there is total-internal reflection 57 of the input-coupled measuring light beam 81.

In the following exemplary embodiments, the waveguide 50 has the following geometry 56: height 266 mm (dimension in the first direction R1), thickness 1.2 mm (dimension in a second direction R2 perpendicular to the first direction R1), width 150 mm (dimension in a third direction R3, illustrated schematically by a cross, perpendicular to the first direction R1 and perpendicular to the second direction R2). The waveguide 50 may be manufactured from for example a glass, optionally a borosilicate glass, and may have a refractive index N1 in the range of 1.45 to 1.5 that depends only weakly on the wavelength L in the spectral range S.

In this case, the measuring light beam 81 coupled into the waveguide 50 propagates through the waveguide 50 in the first direction R1 and is incident on a measuring diffraction structure 51 in a transmission output coupling region 60. The measuring diffraction structure 51 in the transmission output coupling region 60 is configured to deflect the input-coupled measuring light beam 81 through a deflection angle 58 that arises from the wavelength L in a manner dependent on the wavelength L of the measuring light beam 81. Hence, further total-internal reflection 57 of the measuring light beam 81 may be avoided at the interface between the waveguide 50 and surroundings 59 of the waveguide 50, and the measuring light beam 81 may be decoupled from the waveguide 50 and propagate in the surroundings 59 of the waveguide 50 as measuring light beam 82 decoupled from the waveguide 50.

An object 15, which is illustrated schematically as a circle in FIG. 1, is arranged in the surroundings 59 of the waveguide 50. A geometry of the object 15 is such that the object of 15 has sections at different distances from the waveguide 50. The object 15 is arranged in an object region 16. In this case, the object region may be arranged in a capture region (field of view) of the device 10. The object region 16 is a section of surroundings of the waveguide 50 arranged outside of the waveguide 50. The device 10 is configured to emit the measuring light beam 82 into the object region 16. Hence, the output-coupled measuring light beam 82 may reach the object 15 and may be reflected off the object 15 for the purpose of measuring the time of flight 92 from the object 15 in the direction of the waveguide 50. The output-coupled measuring light beam 82 is reflected off the object and propagates in the direction of the waveguide 50 as measuring light beam 85 reflected off the object 15. Here, the propagation of the decoupled measuring light beam 82 and of the reflected measuring light beam 85 are very different from one another to aid a better illustration.

In a sensor input coupling region 65 of the waveguide 50, the measuring light beam 85 in the form of a measuring light beam 86 coupled into the sensor input coupling region 65 and reflected off the object 15 is incident on a measuring diffraction structure 52 in the sensor input coupling region 65. The measuring diffraction structure 52 in the sensor input coupling region 65 is configured to deflect the input-coupled measuring light beam 86 in a manner dependent on the wavelength L of the measuring light beam 86. This can ensure that the measuring light beam 86 is deflected in such a way in the waveguide 50 that the measuring light beam 86 propagates through the waveguide 50 in the first direction R1 and in the process propagates to a sensor output coupling region 70 via a plurality of total-internal reflections 57.

The measuring diffraction structures 51, 52 are configured for wavelength-dependent deflection of the measuring light beam 81, 86 at a wavelength L in the NIR range S. In this case, the wavelength L of the measuring light beam 80, 81, 82, 85, 86 denotes the wavelength L that is determinable in vacuo or in air and/or the wavelength L of the measuring light beam 80 as emitted by the measuring light source 20. Within the waveguide 50, the measuring light beam 81, 86 has a wavelength L that is influenced by the refractive index N1 of the waveguide 50.

In the sensor output coupling region 70, the measuring light beam 86 is decoupled out of the waveguide 50 in such a way that the measuring light beam 80 is steered in the direction of the light sensor 30. To this end, the device 10 comprises an imaging device 31 that is arranged between the waveguide 50 and the light sensor 30. For example, the imaging device 31 comprises a prism, a mirror and/or a lens element.

In this case, the measuring light beam 80, 81, 85 propagating from the measuring light source 20 to the object 15 is depicted with a solid line in FIG. 1, and the measuring light beam 80, 85, 86 reflected off the object 15 and propagating to the light sensor 30 is depicted by a dashed line. Overall, the measuring light beam 80, 81, 82, 85, 86 traverses an optical path length 91 during a time of flight 92. The optical path length 91 and the time of flight 92 depend on the geometry 56 of the waveguide 50, the refractive index N1 of the waveguide 50 and the wavelength-dependent deflection of the measuring light beam 80, 81, 82, 85, 86 by the measuring diffraction structures 51, 52 encompassed by the waveguide 50. The deflection by the measuring diffraction structures 51, 52 with deflection angles 58 that differ for each wavelength L results in different optical paths through the waveguide 50 and hence a number of total-internal reflections 57 within the waveguide 50 that is potentially different for each wavelength L. Hence, an optical wavelength contribution 93 and/or a time-of-flight contribution 94 for the measuring light beam 80 detected by the light sensor 30 arises within the waveguide 50 for the measuring light beam 80, 81, 82, 85, 86. In this case, the path length contribution 93 is the contribution caused by the waveguide 50 to the overall optical path length 91 traversed by the measuring light beam 80, 81, 82, 85, 86. The time-of-flight contribution 94 is the contribution caused by the waveguide 50 to the overall time of flight 92 of the measuring light beam 80, 81, 82, 85, 86 required by said measuring light beam 80, 81, 82, 85, 86 and measured by the device 10.

Hence, the waveguide 50 is arranged such that the measuring light beam 80 emitted by the measuring light source 20 to the object 15 and the measuring light beam 85 reflected off the object 15 to the light sensor 30 are at least partially guided through the waveguide 50, the waveguide 50 comprising the measuring diffraction structures 51, 52 for the wavelength-dependent deflection of the measuring light beam 81, 86 and the reflected measuring light beam 86 traversing the wavelength-dependent path length 91 in the waveguide 50.

The light sensor 30 is connected to the data processing device 90 in a manner allowing communication in order to transmit information relating to the detection of the measuring light beam 80 to the data processing device 90. Hence, the data processing device 90 is able to capture a second time of detection of the measuring light beam 80 by the light sensor 30.

Hence the time of flight 92 of the measuring light beam 80 may be determined by the data processing device 60 as difference between the first time of emitting the measuring light beam 80 by the measuring light source 20 and the second time of detecting the measuring light beam 80 by the light sensor 30.

The data processing device 90 is configured within the measurement of the time of flight 92 to determine an optical path length contribution 93 and/or a time-of-flight contribution 94 to the measuring light beam 80 detected by the light sensor 30, taking into account the wavelength-dependent path length 91 of the emitted and reflected measuring light beam 86 in the waveguide 50. The distance between the object 15 and the device 10 may be determined accurately on the basis of the path length contribution 93 and/or the time-of-flight contribution 94.

The light sensor 30 comprises a pixel matrix with a plurality of picture elements 32. A row, i.e. a one-dimensional arrangement, of picture elements 32 is depicted schematically in FIG. 1. The picture elements 32 of the light sensor 30 are also arranged in a direction perpendicular to the image plane of FIG. 1 and thus form a two-dimensional arrangement of picture elements 32. The picture elements 32 are arranged at a specific position relative to the waveguide 50. The positions of the picture elements 32 are in each case defined by a vertical pixel position vp, which is indicated schematically by an arrow, and by a horizontal pixel position hp, which is schematically indicated by a cross and reaches into the image plane.

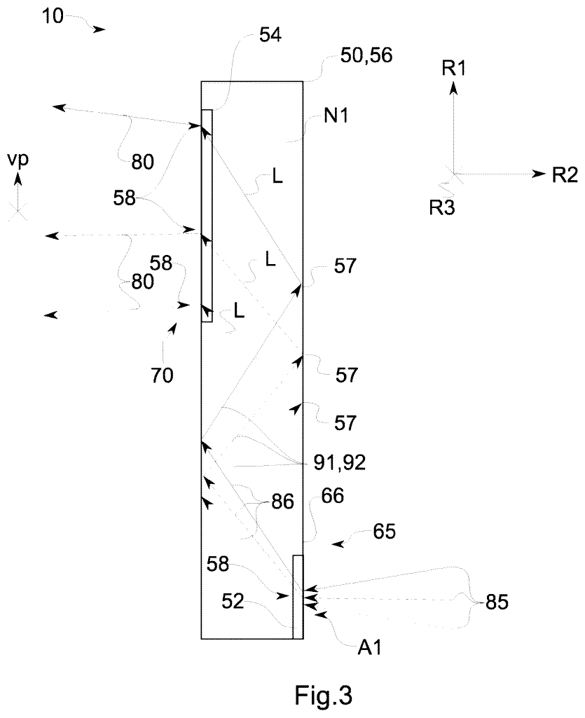

The picture elements 32 are each configured to detect the measuring light beam 80. As described with reference to FIGS. 3 to 9, a wavelength L of the measuring light beam 80 is assignable to each of the picture elements 32. In other words, different picture elements 32 detect different portions of the measuring light beam 80 at different wavelengths L, which traversed different optical paths 91 within the waveguide 50 and which have different times of flight 92. Hence, the picture elements 32 or pixel positions vp, hp may each be assigned an optical path length contribution 93 and/or time-of-flight contribution 94. In this case, it is also possible that the picture elements 32 or their vertical pixel positions vp can be assigned an optical path length contribution 93 and/or time-of-flight contribution 94, while each horizontal angle of the capture region essentially propagates on account of refraction at a different horizontal angle by the waveguide 50. In this case, a different optical path length is given for different horizontal angles and hence horizontal pixel positions hp, whereby each picture element 32 may be assigned a horizontal angle of incidence and hence a horizontal propagation angle in the waveguide 50.

The data processing device 90 is configured to retrieve the optical path length contribution 93 and/or time-of-flight contribution 94 for the picture elements 32 of a respective detected portion of the measuring light beam 80. To this end, the data processing device 90 comprises a memory 95, stored in which is an optical wavelength contribution 93 and/or a time-of-flight contribution 94 for each wavelength L, i.e. for the portion of the measuring light beam 80. The pixel position vp, hp at which the measuring light beam 80 is detected may be captured by the light sensor 30 and transmitted to the data processing device 90. Based on the pixel position vp, hp, the data processing device 90 retrieves the path length contribution 93 and/or time-of-flight contribution 94 corresponding to the pixel position vp, hp from the memory 96 or a lookup table, as illustrated in FIG. 9 by way of example.

In an alternative to that or in addition, the data processing device 90 is configured to calculate the optical path length contribution 93 and/or time-of-flight contribution 94 for the picture elements 32 of a respective detected portion of the measuring light beam 80. To this end, the data processing device 90 comprises a processor 96. In this case, the geometry 56 of the waveguide 50 and the refractive index N1 of the waveguide 50 are known. The optical path length contribution 93 and/or time-of-flight contribution 94 may be calculated based on the number of total-internal reflections 57 within the waveguide 50 and/or the wavelength-dependent deflection angle 58.

When retrieving and/or calculating the optical path length contribution 93 and/or the time-of-flight contribution 94, the optical path length contribution 93 and/or the time-of-flight contribution 94 corresponds to the vertical pixel position vp and the horizontal pixel position hp.

The measuring diffraction structure 52 of the sensor input coupling region 60 is configured to input couple the measuring light beam 86, which was reflected off the object 15 and is incident on a surface 66 of the waveguide 50 at a first angle of incidence A1 of +/−20°, into the waveguide 50 and to input couple the measuring light beam 86, which was reflected off the object 15 and is incident on the surface 66 of the waveguide 50 at a second angle of incidence A2 of +/−20°, into the waveguide 50. In this case, the first angle of incidence A1 is defined in a plane spanned by the first direction R1 and the second direction R2 between a direction of the measuring light beam 86 and a normal vector (not plotted) of the surface 66. In this case, the second angle of incidence A2 is defined in a plane spanned by the second direction R2 and the third direction R3 between a direction of the measuring light beam 86 and a normal vector (not plotted) of the surface 66.

The device 10 comprises an input device 97. The input device 97 and the data processing device 90 are connected to one another in a manner allowing communication so that distance data 98 relating to the object 15 may be acquired or input by way of the input device 97. The data processing device 90 is configured to calibrate the determination of the optical path length 91 and/or the time of flight 92 based on the distance data 98. In the case of a known distance between the object 15 and the device 10, the path length contribution 93 and/or the time-of-flight contribution 94 can be determined, optionally relatively, by using a polychromatic measuring light beam 80 and/or by way of a plurality of measuring light beams 80 at different wavelengths L. As a result, the measurement of the distance between the object 15 and the device 10 may be calibrated. In another embodiment (not shown), the device 10 is connectable to such an input device 97.

In an embodiment not shown here, the device 10 comprises a mirror and/or a prism for deflecting the measuring light beam 82 emerging from the waveguide 50 and/or for deflecting the measuring light beam 85 reflected off the object 15.

In the embodiment of the device 10 shown in FIG. 1, the measuring diffraction structure 51 of the transmission output coupling region 60 and the measuring diffraction structure 52 of the sensor input coupling region 65 are arranged with overlap in the first direction R1. In an embodiment not shown here, the measuring diffraction structure 51 of the transmission output coupling region 60 and the measuring diffraction structure 52 of the sensor input coupling region 65 may be arranged with a partial overlap or no overlap, i.e. disjointly, in the first direction R1.

The measuring diffraction structures 51, 52 encompassed by the waveguide 50 for example are reflective volume holograms, transmissive volume holograms, surface holograms and/or relief gratings, as described in WO 2020/157306 A1. In this case, the arrangement of the measuring diffraction structures 51, 52 may depend on a type of the measuring diffraction structures 51, 52. For example, a reflective measuring diffraction structure 51, 52 may be arranged in a section of the waveguide 50 that faces away from the object 15, and/or a transmissive measuring diffraction structure 51, 52 may be arranged in a section of the waveguide 50 that faces the object 15.

The measuring diffraction structures 51, 52 of the transmission output coupling region 60 and/or of the sensor input coupling region 65, or the sensor input coupling region 65 and/or the transmission output coupling region 60, may be designed such that they do not bring about any optical imaging function in addition to deflection. However, it is also possible that the measuring diffraction structures 51, 52, or the sensor input coupling region 65 and/or the transmission output coupling region 60, provide an optical imaging function in addition to deflection and thus bring about optical imaging. Thus, the optical imaging function may realize for example the function of a converging lens or diverging lens, a concave or convex mirror, wherein the curved surfaces can be (centered or off-centered) spherically curved or aspherically curved surfaces. Hence, the properties of the waveguide 50 may be adapted in order for example to be able to arrange an image plane or a focal plane in the object region 16.

In another embodiment (not shown), the waveguide 50 comprises only one of the measuring diffraction structures 51, 52 in order to obtain a more cost effective and/or simpler structure of the device 10. A beam splitter may be provided in the process.

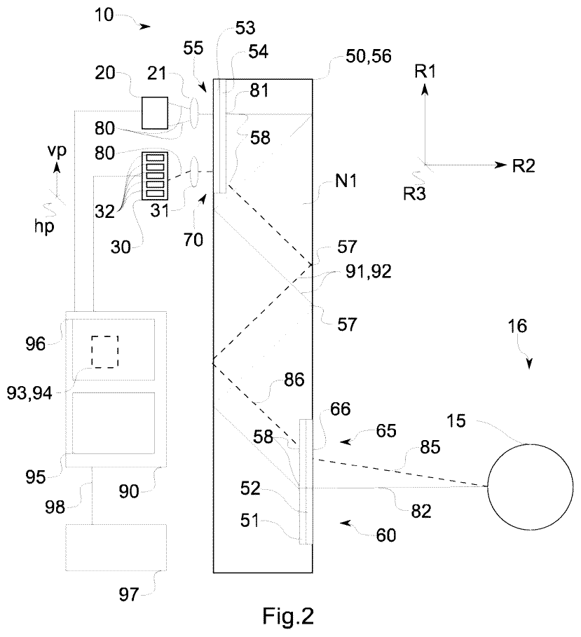

FIG. 2 shows a schematic illustration of a device 10 for measuring a time of flight 92 according to an optional aspect of the disclosure. The device 10 in FIG. 2 is described with reference to the device 10 in FIG. 1. In so doing, the differences between the devices 10 in accordance with FIGS. 1 and 2 are described.

The waveguide 50 of the device 10 in accordance with FIG. 2 comprises a measuring diffraction structure 53 in the transmission input coupling region 55. The waveguide 50 moreover comprises a measuring diffraction structure 54 in the sensor output coupling region 70. In another embodiment, not shown here, the device 10 may comprise one of the two aforementioned measuring diffraction structures 53, 54, i.e. either the measuring diffraction structure 53 of the transmission input coupling region 55 or the measuring diffraction structure 54 of the sensor output coupling region 70.

In a manner analogous to the measuring diffraction structure 51 of the transmission output coupling region 60 or the measuring diffraction structure 52 of the sensor input coupling region 65, the measuring diffraction structure 53 of the transmission input coupling region 55 and of the sensor output coupling region 70 are configured for wavelength-dependent deflection of the measuring light beam 81, 86 at a wavelength L in the NIR range S. In this case, the measuring diffraction structure 53 of the transmission input coupling region 55 and the measuring diffraction structure 51 of the transmission output coupling region 70 may be configured so as to bring about a similar wavelength-dependent deflection. Analogously, the measuring diffraction structure 54 of the sensor output coupling region 70 and the measuring diffraction structure 52 of the sensor input coupling region 65 may be configured so as to bring about a similar wavelength-dependent deflection. Hence, a measuring light beam 80, 85 to be coupled and an output-coupled measuring light beam 80, 82 may experience a mutually similar deflection by the measuring diffraction structure 51, 52, 53, 54. In this case, FIG. 2 shows the deflection by the measuring diffraction structure 51, 52, 53, 54 purely schematically. Optionally, the deflection angles 58 have not been illustrated true to scale. Optionally, the deflection angle of the measuring diffraction structure 53 of the transmission input coupling region 55 has not been plotted true to scale and may be larger than plotted in order to obtain total-internal reflection of the input-coupled measuring light beam 81.

In the embodiment of the device 10 shown in FIG. 2, the measuring diffraction structure 53 of the transmission input coupling region 55 and the measuring diffraction structure 54 of the sensor output coupling region 70 are arranged with overlap in the first direction R1. In an embodiment not shown here, the measuring diffraction structure 53 of the transmission input coupling region 55 and the measuring diffraction structure 54 of the sensor output coupling region 70 may be arranged with a partial overlap or no overlap, i.e. disjointly, in the first direction R1.

The measuring diffraction structures 53, 54 of the transmission input coupling region 55 and/or of the sensor output coupling region 70, or the transmission input coupling region 55 and/or the sensor output coupling region 70, may be designed such that they do not bring about any optical imaging function in addition to deflection. However, it is also possible that the measuring diffraction structures 53, 54 or transmission input coupling region 55 and/or of the sensor output coupling region 70 provide an optical imaging function in addition to deflection and thus bring about optical imaging. Thus, the optical imaging function may realize for example the function of a converging lens or diverging lens, a concave or convex mirror, wherein the curved surfaces can be (centered or off-centered) spherically curved or aspherically curved surfaces.

FIG. 3 shows a schematic illustration of a waveguide 50 of a device 10 for measuring a time of flight 92 according to an optional aspect of the disclosure, in order to illustrate a wavelength-dependent optical path length contribution 93. FIG. 3 shows a simplified representation of the waveguide 50 from FIG. 2. In this case, FIG. 3 shows the waveguide 50 with the measuring diffraction structure 52 of the sensor input coupling region 65 and the measuring diffraction structure 54 of the sensor output coupling region 70. The measuring diffraction structure 53 of the transmission input coupling region 55 and the measuring diffraction structure 51 of the transmission output coupling region 60 are not depicted in FIG. 3. The portions of the measuring light beam 80, 85, 86 illustrated schematically in FIG. 3 show the measuring light beam 85 that was reflected off the object 15 (not shown), the measuring light beam 86 coupled into the waveguide 50 in the sensor input coupling region 65 and the measuring light beam 80 decoupled from the waveguide 50 in the sensor output coupling region 70.

FIG. 3 illustrates three different portions of the measuring light beam 80, 85, 86 with in each case mutually different wavelengths L within the NIR range S. In this case, the portions of the measuring light beam 80, 85, 86 with the mutually different wavelengths L are represented by different types of lines. One portion of the measuring light beam 80, 85, 86 is respectively depicted using arrows with a solid line, with a dash-dotted line and with a dashed line. As described in relation to FIG. 1, the measuring light beam 85 is incident on the surface 66 of the waveguide 50 at a first angle of incidence A1 and coupled into the waveguide 50 depending on the wavelength L.

According to FIG. 3, the portions of the measuring light beam 85 are deflected by the measuring diffraction structure 52 of the sensor input coupling region 65 when input coupling the measuring light beam 85 into the waveguide 50 in the sensor input coupling region 65. In this case, deflection is implemented such that the various portions of the measuring light beam 85, 86 have different deflection angles 58 and traverse different optical paths with, accordingly, different optical path lengths 91 and different times of flight 92 within the waveguide 50, i.e. lead to different path length contributions 93 and/or time-of-flight contributions 94.

The measuring light beam 86 propagates through the waveguide 50 and is incident on the measuring diffraction structure 54 of the sensor output coupling region 70, where it is deflected in accordance with the respective wavelength L of the respective portion of the measuring light beam 86 and decoupled from the waveguide 50. In the process, the output-coupled measuring light beam 80 is steered in the direction of the light sensor 30 (not shown in FIG. 3). As a result of the deflection of the measuring light beam 80, 86 by the measuring diffraction structure 54 of the sensor output coupling region 70, the various portions of the measuring light beam 80 are steered to picture elements 32 (not shown in FIG. 3) with mutually different vertical pixel positions vp, as depicted schematically in FIG. 3. Hence, the various portions of the measuring light beam 80, 85, 86 are detected by different picture elements 32 of the light sensor 30, depending on the wavelength L. The different picture elements 32 of the light sensor 30 may be assigned an optical path and hence an optical path length 91 and a time of flight 92 of the measuring light beam 80, 85, 86.

The arrangement of the measuring diffraction structure 51, 52, 53, 54 and optionally an additional deflection function of the measuring diffraction structure 51, 52, 53, 54 allow the light to be guided to a region of the device 10 not visible to the user. Hence, the measuring light source 20 and the light sensor 30 may be arranged in a manner hidden from the user.

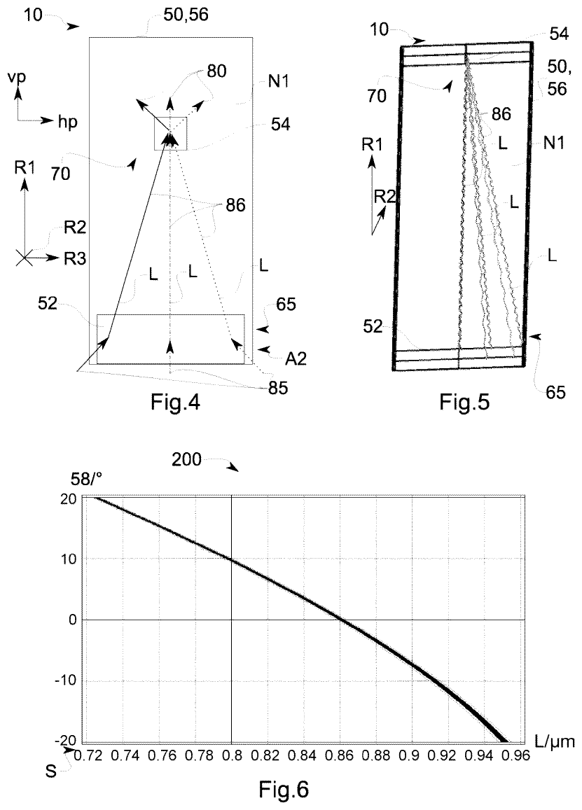

FIG. 4 shows a schematic illustration of a waveguide 50 of a device 10 for measuring a time of flight 92 according to an optional aspect of the disclosure, in order to illustrate a wavelength-dependent optical path length contribution 93. Here, FIG. 4 shows the waveguide 50 of the device 10 as described in relation to FIGS. 2 and 3. In so doing, FIG. 4 shows a different perspective of the waveguide 50. As described in relation to FIG. 1, the measuring light beam 85 is incident on the surface 66 of the waveguide 50 at a second angle of incidence A2 and coupled into the waveguide 50 depending on the wavelength L.

According to FIG. 4, the measuring light beam 80, 85, 86 is deflected by the measuring diffraction structure 52, 54 according to the wavelength L, as described in relation to FIG. 3. However, the horizontal component of the deflection preferably has no wavelength dependence, or only a small wavelength dependence, and is substantially determined by an entry angle on account of the refraction of the light beam upon entry into the waveguide 50.

Advantageously, this is due to the design of the measuring diffraction structure 52, 54 and optionally due to its grating vector. As a result, each portion of the measuring light beam 80, 85, 86 is decoupled from the waveguide 50 in the sensor output coupling region 70 as a result of the measuring diffraction structure 54 and is incident, depending on entry angle, on a picture element 32 that is assignable to the entry angle and has a horizontal pixel position hp assigned to the entry angle.

The measuring diffraction structure 52 of the sensor input coupling region 65 has a height of 16 mm, a width of 150 mm and a thickness of 100 μm. The measuring diffraction structure 54 of the sensor output coupling region 70 has a height of 16 mm, a width of 16 mm and a thickness of 100 μm.

FIG. 5 shows a schematic illustration of a waveguide 50 of a device 10 for measuring a time of flight 92 according to an optional aspect of the disclosure, in order to illustrate a wavelength-dependent optical path length contribution 93. Here, FIG. 5 shows the waveguide 50 of the device 10 as described in relation to FIGS. 2 to 4. In this case, FIG. 5 shows a further perspective of the waveguide 50, the illustration only showing the measuring light beam 86 within the waveguide 50. In this case, the waveform of the measuring light beam 86 shows that the measuring light beam 86 propagates through the waveguide 50 with a number of total-internal reflections 57 from the measuring diffraction structure 52 of the sensor input coupling region 65 to the measuring diffraction structure 54 of the sensor output coupling region 70.

FIG. 6 shows a schematic illustration of a deflection curve 200 of a measuring diffraction structure 51, 52, 53, 54 of a waveguide 50 of a device 10 for measuring a time of flight 92 according to an optional aspect of the disclosure. In this case, FIG. 6 shows a relationship between a deflection angle 58 and the wavelength L for the measuring diffraction structures 51, 52, 53, 54 shown in relation to FIGS. 1 to 5. In this context, it is evident that there is input coupling with a monotonically decreasing deflection angle 58 as the wavelength L in the spectral range S increases, wherein the deflection angle 58 is for instance +20° at a wavelength L of 720 nm and for instance −20° at a wavelength L of 950 nm.

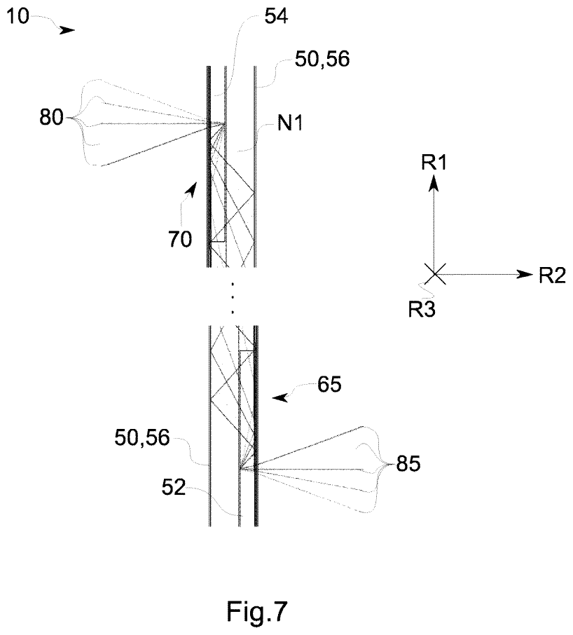

FIG. 7 shows a schematic illustration of a waveguide 50 of a device 10 for measuring a time of flight 92 according to an optional aspect of the disclosure, in order to illustrate a wavelength-dependent optical path length contribution 93. FIG. 7 is described with reference to FIG. 3 and the description thereof. In this case, input and output coupling structures, i.e. the measuring diffraction structures 52, 54 of the sensor input coupling region 65 and of the sensor output coupling region 70, are designed such that the incident angles A1, A2 are decoupled from the waveguide 50 unchanged, i.e. the measuring light beam 80, 85, 86 experiences a deflection through the same deflection angle 58 during input coupling and output coupling, depending on the wavelength L. Thus, both measuring diffraction structures 52, 54 have the same optical function and can be produced in mutually similar fashion. Different propagation angles and optical path lengths arise within the waveguide 50 on account of the different angles of incidence and the dispersion of the waveguide material.

According to FIG. 7, the measuring light beam 80, 85, 86 is deflected by the measuring diffraction structures 52, 54, as described in relation to FIG. 6. A measuring light beam 80, 85, 86 at an angle of incidence A1 of −20° is coupled at a wavelength L of 951 nm and, according to the geometry 56 of the waveguide 50 described with reference to FIGS. 1 and 5 and the measuring diffraction structures 52, 54 into the waveguide 50, has an optical path length contribution 93 of 477.4 mm due to the propagation through the waveguide 50. A measuring light beam 80, 85, 86 at an angle of incidence A1 of 0° is (input) coupled at a wavelength L of 861 nm and has an optical path length contribution 93 of 411.6 mm. A measuring light beam 80, 85, 86 at an angle of incidence A1 of +20° is (input) coupled at a wavelength L of 725 nm and has an optical path length contribution 93 of 365.9 mm.

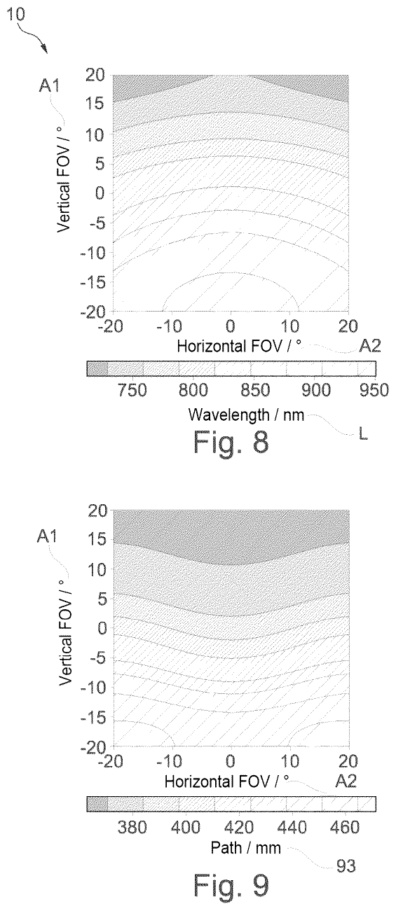

FIG. 8 shows a schematic illustration of an optional dependence of a wavelength L on a first angle of incidence A1 and on a second angle of incidence A2 of a measuring diffraction structure 51, 52, 53, 54 of a waveguide 50 of a device 10 for measuring a time of flight 92 according to an aspect of the disclosure. In this case, FIG. 8 represents the generalization that relates to the two angles of incidence A1, A2 of the deflection curve 200 as per FIG. 6. FIG. 8 illustrates the angles of incidence A1, A2 at which a wavelength L can be coupled into the waveguide 50 and/or decoupled therefrom using one of the measuring diffraction structures 51, 52, 53, 54. In this case, the first angle of incidence A1 is an angle between a normal of the surface 66 of the waveguide 50 and a direction of the measuring light beam 80, 81, 86 in or projected into a plane spanned by the first direction R1 and the second direction R2. The second angle of incidence A2 is an angle between a normal of the surface 66 of the waveguide 50 and a direction of the measuring light beam 80, 81, 86 in or projected into a plane spanned by the second direction R2 and the third direction R3 (see FIGS. 1 to 7).

FIG. 9 shows a schematic illustration of an optional dependence of an optical path length contribution 93 on a first angle of incidence A1 and on a second angle of incidence A2 of a waveguide 50 of a device 10 for measuring a time of flight 92 according to an aspect of the disclosure.

In the process, it is evident that the optical path length contribution 93 can be inferred from the angles of incidence A1, A2. According to FIG. 8, once again, the wavelength L can likewise be inferred from the angles of incidence A1, A2. Hence, a corresponding path length contribution 93 arises for each wavelength L, and said path length contribution is unique with respect to the second angle of incidence A2 thanks to the symmetry of the FIGS. 8 and 9. Hence, the angles of incidence A1, A2, the optical path length contribution 93 and the wavelength L are related to one another, said relationship being predetermined by the geometry of the waveguide 50 and the nature of the measuring diffraction structures 51, 52, 53, 54. The information according to FIG. 9 may be retrievably stored in a memory 96 of a device according to FIGS. 1 to 7. Hence, FIG. 9 may serve as a lookup table, wherein the wavelength L of the measuring light beam 80 is determinable by the horizontal pixel position hp and the vertical pixel position vp, as described in relation to FIGS. 1, 3 and 4. The path length distribution caused by the waveguide 50, i.e. the distribution of the path length contributions 93, is subtracted from the distance distribution for the distance between the object 15 and the device 10, as determined by the time-of-flight measurement, in order to obtain a corrected measurement result for the distance distribution.

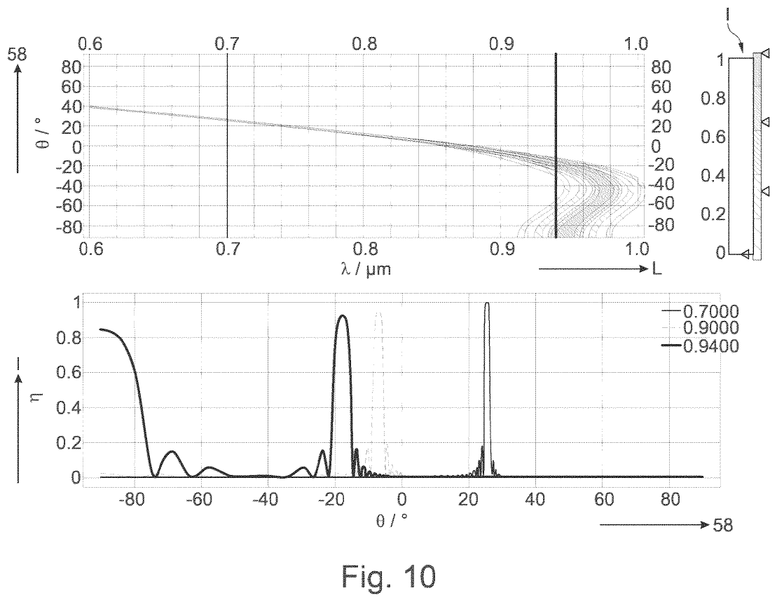

FIG. 10 shows a schematic illustration of a deflection efficiency I of a measuring light beam 80, 81, 82, 85, 86 deflected by a measuring diffraction structure 51, 52, 53, 54. In this case, such a measuring diffraction structure 51, 52, 53, 54 is one of the measuring diffraction structures 51, 52, 53, 54 described with reference to the preceding FIGS. In this context, the upper graph of FIG. 10 shows the deflection efficiency I as a function of the deflection angle 58 and the wavelength L in the spectral range S. In so doing, it is evident that, at comparatively short wavelengths L, the deflection efficiency I is localized comparatively precisely about a certain deflection angle 58, and the localization about the deflection angle 58 corresponding to the wavelength L reduces as the wavelength L increases. This is also shown in the lower graph of FIG. 10. It shows curves for various wavelengths L, wherein a short wavelength L causes a substantially unimodal and localized angle distribution about a deflection angle 58, while the angle distribution about a respective deflection angle 58 is less localized at longer wavelengths L. The measuring diffraction structure 51, 52, 53, 54 may be produced by an appropriate exposure of the waveguide 50. The deflection efficiency I and hence the object region 16 or the field of view (FOV) can be set by one or more appropriate exposure angles during the exposure of the waveguide 50. By increasing the thickness of the volume hologram (increasing the number of Bragg planes), it is possible to improve the angle selectivity in accordance with the requirements, and so a more narrowband spectrum is decoupled at a respective angle, and hence a time-of-flight uncertainty is reduced.

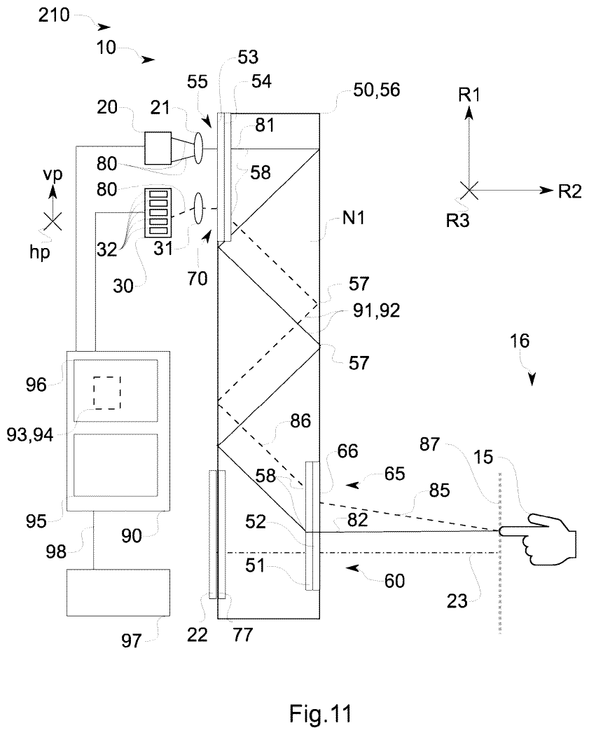

FIG. 11 shows a schematic illustration of a device 10 for measuring a time of flight 92 according to an optional aspect of the disclosure. In the description of FIG. 11, reference is made to the description of the preceding FIGS.

The device 10 comprises an image light source 22 for emitting a visible image light beam 23. For example, the image light source 22 comprises a matrix of light-emitting diodes and/or an LC display. The waveguide 50 comprises an image diffraction structure 77 for wavelength-dependent deflection of the image light beam 23. Hence, a user interface 87 spaced apart from the waveguide 50 in the second direction R2 is imaged or reconstructed, as described in WO 2020/157306 A1 with respect to the illumination and projection system. In this case, the image light source 22 may be arranged in such a way that the image light source 22 and the image diffraction structure 77 are arranged in a manner spaced apart from one another in the first direction R1. Hence, a wavelength-dependent transparency of the device 10 in the region of the image diffraction structure 77 and/or a more varied arrangement of the components of the device 10 may be obtained.

The data processing device 90 is configured to capture a user input 24 by the user interface 87 based on the time of flight 92 of the measuring light beam 80. In this case, the object 15 whose distance from the device 10 should be determined is a body part of a user, for example. The user moves the object 15 in order to interact with the user interface 87. In order to image a response to the user input 24, the device 10 is configured to control the image light source 22 based on the optical path length 91 and/or the time of flight 92 of the measuring light beam 80, i.e. based on the distance between the object 15 and the device 10.

The embodiment of the device 10 shown in FIG. 11 may be applicable in a user terminal 210 and is encompassed by the user terminal 210 here. For example, the user terminal 210 is a smartphone, a computer, optionally a portable computer, and/or a device on a motor vehicle. Optionally, this renders possible the realization of gesture monitoring and/or a motion detector. The arrangement of the image diffraction structure 77 and optionally an additional deflection function of the image diffraction structure 77 allow the light to be guided to a region of the user terminal 210 not visible to the user.

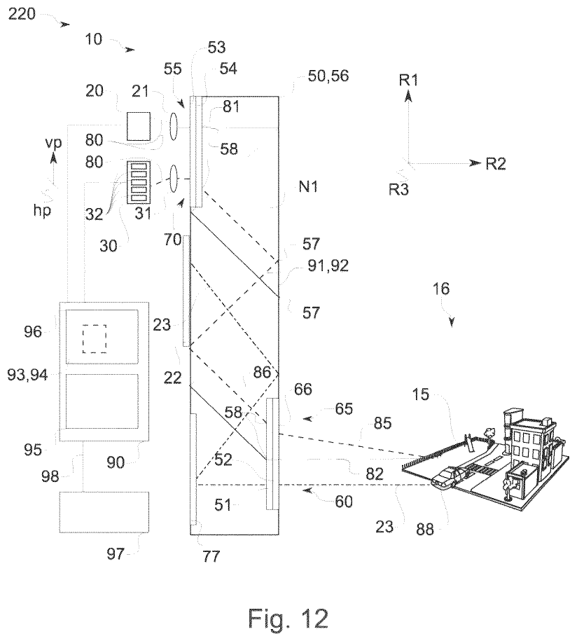

FIG. 12 shows a schematic illustration of a device 10 for measuring a time of flight 91 according to an optional aspect of the disclosure. In the description of FIG. 12, reference is made to the description of the preceding FIGS.

The device 10 is configured to virtually image an imaging object 88, which is spaced apart from the waveguide 50 in a second direction R2, relative to the object 15. Hence, a user can gaze through the waveguide 50 and sees the imaging object 88 arranged relative to the object 15. To this end, the image light source 22 and the image diffraction structure 77 are arranged in a manner spaced apart from one another in the first direction R1.

The device 10 is configured to control the image light source 22 dynamically and/or on the basis of a captured movement of the object 15.

The embodiment shown in FIG. 12 may be applicable for a detection and illumination apparatus 220 and is encompassed by the detection and illumination apparatus here.

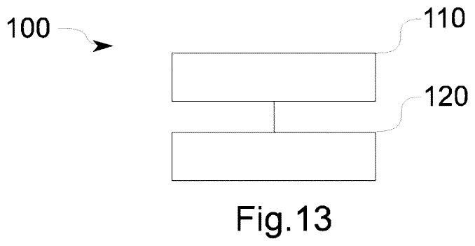

FIG. 13 shows a flowchart of an optional method 100 for measuring a time of flight 92 according to an aspect of the disclosure. The method 100 may be performed using one of the devices 10 for measuring the time of flight 92 as described in the preceding FIGS.

The method 100 is a method 100 for measuring the time of flight 92 of a measuring light beam 80. The method 100 includes: guiding 110 the measuring light beam 80 to an object 15 situated in an object region 16 of the device 10 and the measuring light beam 85 reflected off the object 15 to a light sensor 30 at least partially through a waveguide 50 having a measuring diffraction structure 51, 52 for the wavelength-dependent deflection of the measuring light beam 81, 86, the measuring light beam 86 traversing a wavelength-dependent path length 91 in the waveguide 50.

There is a determination 120 of an optical path length contribution 93 and/or a time-of-flight contribution 94 to the measuring light beam 80 detected by the light sensor 30, taking into account the wavelength-dependent path length 91 of the measuring light beam 86 in the waveguide 50.

### LIST OF REFERENCE CHARACTERS

10 Device for measuring a time of flight
15 Object
16 Object region
20 Measuring light source
21 Imaging device
22 Image light source
23 Image light beam
24 User input
30 Light sensor
31 Imaging device
50 Waveguide
51 Measuring diffraction structure of the transmission output coupling region
52 Measuring diffraction structure of the sensor input coupling region
53 Measuring diffraction structure of the transmission input coupling region
54 Measuring diffraction structure of the sensor output coupling region
55 Transmission input coupling region
56 Geometry
57 Total-internal reflection
58 Deflection angle
59 Surroundings
60 Transmission output coupling region
65 Sensor input coupling region
70 Sensor output coupling region
75 Image input coupling region
76 Image output coupling region
77 Image diffraction structure
80 Measuring light beam
81 Input-coupled measuring light beam
82 Measuring light beam emerging from the waveguide in the direction of the object
85 Reflected measuring light beam
86 Measuring light beam coupled into the sensor input coupling region
87 User interface
88 Imaging object
90 Data processing device
91 Optical path length
92 Time of flight
93 Optical path length contribution
94 Time-of-flight contribution
95 Memory
96 Processor
97 Input device
98 Distance data
100 Method
110 Guiding of the measuring light beam
120 Determination
200 Deflection curve
210 User terminal
220 Detection and illumination apparatus
A1 Angle of incidence
A2 Angle of incidence
I Deflection efficiency
L Wavelength
N1 Refractive index
R1 First direction
R2 Second direction
R3 Third direction
S NIR range
hp Horizontal pixel position
vp Vertical pixel position

What is claimed is:

1. A device for measuring a time of flight of a measuring light beam, comprising a measuring light source for emitting the measuring light beam, a light sensor for detecting the measuring light beam, a waveguide, and a data processing device, wherein:
the waveguide is designed to guide the measuring light beam emitted by the measuring light source to an object situated in an object region of the device and the measuring light beam reflected off the object to the light sensor at least partially through the waveguide, wherein the waveguide includes a measuring diffraction structure for wavelength-dependent deflection of the measuring light beam and wherein the measuring light beam traverses a wavelength-dependent path length in the waveguide, and
the data processing device is configured to determine, when measuring the time of flight, an optical path length contribution and/or a time-of-flight contribution for the measuring light beam detected by the light sensor, taking into account the wavelength-dependent path length of the measuring light beam within the waveguide.

2. The device according to claim 1, wherein the measuring diffraction structure is configured for wavelength-dependent deflection of the measuring light beam in a near infrared spectral range.

3. The device according to claim 1, wherein the light sensor includes a plurality of picture elements, and the data processing device is configured to retrieve and/or calculate the optical path length contribution and/or time-of-flight contribution for a plurality of the picture elements of a respective detected portion of the measuring light beam.

4. The device according to claim 1, wherein the optical path length contribution and/or the time-of-flight contribution corresponds to a vertical pixel position and a horizontal pixel position.

5. The device according to claim 4, wherein the measuring diffraction structure is configured to couple the measuring light beam, which was reflected off the object and is incident on a surface of the waveguide at a first angle of incidence of +/−20°, into the waveguide and/or to couple the measuring light beam, which was reflected off the object and is incident on the surface of the waveguide at a second angle of incidence, defined perpendicular to the first angle of incidence, of +/−20°, into the waveguide.

6. The device according to claim 1, wherein the data processing device includes an input device, the input device being configured to capture distance data related to the object, the data processing device being configured to calibrate the determination of the optical path length and/or the time of flight based on the distance data.

7. The device according to claim 1, wherein the device comprises an image light source for emitting a visible image light beam, and the waveguide includes an image diffraction structure for wavelength-dependent deflection of the image light beam.

8. The device according to claim 7, wherein the device is configured to control the image light source based on the optical path length and/or the time of flight of the measuring light beam.

9. The device according to claim 8, wherein the device is configured to image a user interface that is spaced apart from the waveguide in a second direction and to capture a user input by way of the user interface based on the time of flight of the measuring light beam.

10. The device according to claim 7, wherein the device is configured to image an imaging object, which is spaced apart from the waveguide in a second direction, relative to the object.

11. The device according to claim 7, wherein the device is configured to control the image light source dynamically and/or based on a captured movement of the object.

12. The device according to claim 1, wherein the device comprises a mirror and/or a prism for deflecting the measuring light beam emerging from the waveguide and/or for deflecting the measuring light beam reflected off the object.

13. A user terminal comprising a device according to claim 1.

14. A detection and illumination apparatus comprising a device according to claim 1.

15. A method for measuring a time of flight of a measuring light beam, the method comprising:
guiding the measuring light beam to an object situated in an object region and the measuring light beam reflected off the object to a light sensor at least partially through a waveguide having a measuring diffraction structure for a wavelength-dependent deflection of the measuring light beam, the measuring light beam traversing a wavelength-dependent path length in the waveguide; and
determining an optical path length contribution and/or a time-of-flight contribution for the measuring light beam detected by the light sensor, taking into account the wavelength-dependent path length of the measuring light beam within the waveguide.

16. The method according to claim 15, wherein the optical path length contribution and/or time-of-flight contribution is determined based on a wavelength-dependent number of total-internal reflections within the waveguide and/or a wavelength-dependent deflection angle within the waveguide.

17. A non-tangible computer-readable medium, comprising commands which, when the commands are executed by a computer, cause the computer to perform the method according to claim 15.

18. A data processing device, the data processing device comprising a processor being configured to perform the method according to claim 15.
